(19) United States
(12) Patent Application Publication
(10) Pub. No.: US 2025/0251726 A1
(43) Pub. Date: Aug. 7, 2025

(54) DRIVING ASSISTANCE SYSTEM, DRIVING ASSISTANCE APPARATUS, AND DRIVING ASSISTANCE METHOD

(71) Applicant: NEC Corporation, Minato-ku, Tokyo (JP)

(72) Inventors: Ryutaro YAMAGUCHI, Tokyo (JP); Dai KANETOMO, Tokyo (JP)

(73) Assignee: NEC Corporation, Minato-ku, Tokyo (JP)

(21) Appl. No.: 18/856,923

(22) PCT Filed: Apr. 28, 2022
(86) PCT No.: PCT/JP2022/019372

§ 371 Date: Oct. 15, 2024

(51) Int. Cl. G05D 1/224; G05D 1/82; G05D 107/70

(52) U.S. Cl. CPC G05D 1/2249; G05D 1/82; G05D 2107/70

(57) ABSTRACT

A driving assistance system (1001) according to the present disclosure is a driving assistance system including: an acquisition unit (11) that acquires information regarding a driving operation amount of a moving object; a specifying unit (12) that specifies a region in which the moving object can travel based on the information acquired by the acquisition unit (11); and a display information generation unit (13) that displays the region specified by the specifying unit (12) to a user.

### TECHNICAL FIELD

The present disclosure relates to a driving assistance system, a driving assistance apparatus, and a driving assistance method.

### BACKGROUND ART

Patent Literature 1 describes a driving assistance apparatus for a forklift. The driving assistance apparatus for a forklift described in Patent Literature 1 displays a trajectory of a rear wheel when the forklift travels at a predetermined steering angle as a maximum turning trajectory to be superimposed on an expected travel trajectory based on a steering angle.

### CITATION LIST

### Patent Literature

Patent Literature 1: Japanese Unexamined Patent Application Publication No. 2020-083572

### SUMMARY OF INVENTION

### Technical Problem

As described above, the driving assistance apparatus for a forklift described in Patent Literature 1 displays, as the maximum turning trajectory, the trajectory of the rear wheel when the forklift travels at the predetermined steering angle.

However, when the forklift is actually driven, the forklift is limited in turning performance due to a moving speed of the forklift and a limit of performance of a steering mechanism. Therefore, in the driving assistance apparatus for a forklift described in Patent Literature 1, there is a possibility that a trajectory along which actual travel is impossible is displayed as the maximum turning trajectory, and there is a problem that driving assistance cannot be sufficiently executed.

The present disclosure has been made to solve such a problem, and an object thereof is to provide a driving assistance system, a driving assistance apparatus, and a driving assistance method capable of improving operability and safety in driving of a moving object.

### Solution to Problem

A driving assistance system according to the present disclosure is a driving assistance system including:
an acquisition unit that acquires information regarding a driving operation amount of a moving object;
a specifying unit that specifies a region where the moving object is travelable based on the information regarding the driving operation amount acquired by the acquisition unit; and
a display information generation unit that displays the region specified by the specifying unit to a user.

A driving assistance apparatus according to the present disclosure is a driving assistance apparatus including:
an acquisition unit that acquires information regarding a driving operation amount of a moving object;
a specifying unit that specifies a region where the moving object is travelable based on the information regarding the driving operation amount acquired by the acquisition unit; and
a display information generation unit that displays the region specified by the specifying unit to a user.

A driving assistance method according to the present disclosure is a driving assistance method including:
acquiring information regarding a driving operation amount of a moving object;
specifying a region where the moving object is travelable based on the acquired information regarding the driving operation amount; and
displaying the specified region to a user.

### Advantageous Effects of Invention

According to the present disclosure, it is possible to provide the driving assistance system, the driving assistance apparatus, and the driving assistance method capable of improving the operability and safety in driving of the moving object.

### BRIEF DESCRIPTION OF DRAWINGS

FIG. 1 is a block diagram illustrating a configuration of a driving assistance system according to a first example embodiment.

FIG. 2 is a block diagram illustrating a configuration of a driving assistance apparatus according to the first example embodiment.

FIG. 3 is a flowchart illustrating an operation of the driving assistance apparatus according to the first example embodiment.

FIG. 4 is a block diagram illustrating a configuration of a driving assistance system according to a second example embodiment.

FIG. 5 is a schematic overhead view illustrating an example of a moving object according to the second example embodiment.

FIG. 6 is a schematic overhead view illustrating an example of a travelable region according to the second example embodiment.

FIG. 7 is a schematic overhead view illustrating an example of a boundary line of a travelable region according to the second example embodiment.

FIG. 8 is a schematic overhead view illustrating an example of a boundary line of a travelable region according to the second example embodiment.

FIG. 9 is a schematic side view illustrating an example of a boundary line of a travelable region according to the second example embodiment.

FIG. 10 is a schematic overhead view illustrating an example of a boundary line of a travelable region according to the second example embodiment.

FIG. 11 is a schematic overhead view illustrating an example of a boundary line of a travelable region according to the second example embodiment.

FIG. 12 is a schematic overhead view illustrating an example of a travelable region according to the second example embodiment.

FIG. 13 is a schematic overhead view illustrating an example of a travelable region according to the second example embodiment.

FIG. 14 is a schematic overhead view illustrating a display example of a travelable region according to the second example embodiment.

FIG. 15 is a schematic overhead view illustrating a display example of a travelable region according to the second example embodiment.

FIG. 16 is a block diagram illustrating an example of a driving assistance apparatus according to the second example embodiment.

FIG. 17 is a flowchart illustrating an operation of the driving assistance apparatus according to the second example embodiment.

### EXAMPLE EMBODIMENT

### First Example Embodiment

### <Configuration of Driving Assistance System>

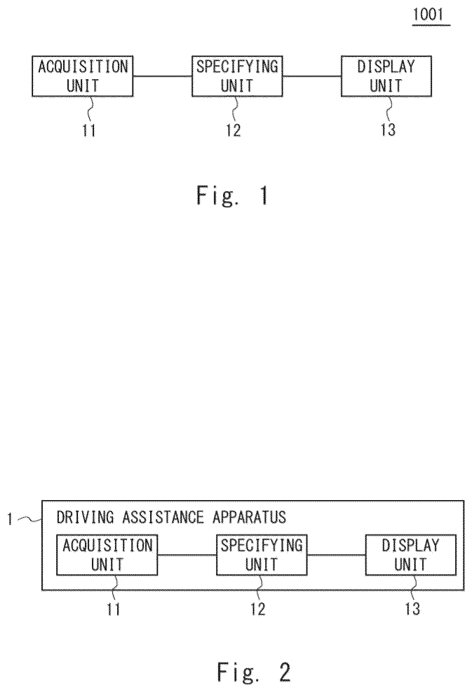

Hereinafter, a driving assistance system according to a first example embodiment will be described in detail with reference to the drawings. FIG. 1 is a block diagram illustrating a configuration of the driving assistance system according to the first example embodiment.

A driving assistance system 1001 according to the present example embodiment assists a user who drives a moving object. More specifically, the driving assistance system 1001 specifies a region where the moving object can travel based on information regarding a driving operation amount of the moving object, and displays the specified region to the user.

The driving assistance system 1001 includes an acquisition unit 11, a specifying unit 12, and a display information generation unit 13.

The acquisition unit 11 acquires the information regarding the driving operation amount of the moving object.

Here, the information regarding the driving operation amount is information regarding a traveling speed and a traveling direction of the moving object. The information regarding the driving operation amount may include, for example, information regarding a drive mechanism that causes the moving object to travel and information regarding a steering mechanism that adjusts the traveling direction of the moving object.

Note that the information regarding the driving operation amount may be, for example, an actual measurement value detected by a sensor attached to each mechanism that adjusts the traveling speed and the traveling direction of the moving object, may be a parameter value included in a control signal input to each mechanism, or may be an upper limit value, a lower limit value, or a prescribed value determined in advance for various parameter values of each mechanism.

The acquisition unit 11 outputs the acquired information to the specifying unit 12.

The specifying unit 12 specifies the region where the moving object can travel based on the information acquired by the acquisition unit 11. For example, the specifying unit 12 may specify a boundary line of the region where the moving object can travel based on the acquired information, and specify a region surrounded by the specified boundary line as the region where the moving object can travel. The specifying unit 12 outputs the specified region to the display information generation unit 13.

The display information generation unit 13 generates display information for displaying the region specified by the specifying unit 12 to the user. The display information generation unit 13 may be configured as, for example, an apparatus including a display, may have a function of displaying the generated display information, or may transmit the generated display information to an apparatus different from the apparatus including the display information generation unit 13.

Note that the driving assistance system 1001 may be implemented as a single apparatus. That is, the driving assistance system 1001 may be implemented as a driving assistance apparatus 1 as illustrated in FIG. 2.

In addition, functions of driving assistance system 1001 may be distributed among a plurality of apparatuses. For example, a cloud apparatus capable of communicating with a moving object 2 may execute some of the functions of the driving assistance system 1001. For example, the cloud apparatus may include the acquisition unit 11 and the specifying unit 12, and a terminal used by the user may include the display information generation unit 13.

### <Operation of Driving Assistance System>

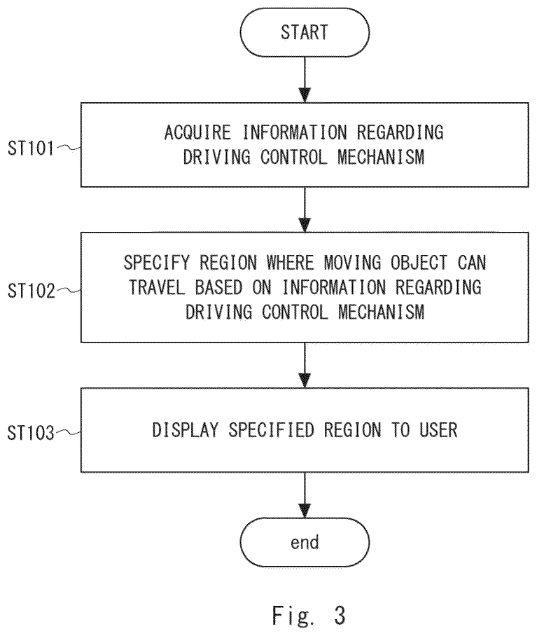

Next, an operation of the driving assistance system according to the first example embodiment, that is, a driving assistance method will be described in detail with reference to the drawings. FIG. 3 is a flowchart illustrating the operation of the driving assistance system according to the first example embodiment. Note that FIGS. 1 and 2 will be appropriately referred to in the following description.

First, the acquisition unit 11 acquires information regarding a driving operation amount of a moving object (step ST101), and then the specifying unit 12 specifies a region where the moving object can travel based on the information acquired by the acquisition unit 11 (step ST102). Finally, the display information generation unit 13 displays the specified region to a user (step ST103), and the driving assistance system 1001 ends the series of operations.

As described above, the driving assistance system 1001 according to the present example embodiment specifies the region where the moving object can travel based on the information regarding the driving operation amount of the moving object and displays the region to the user.

According to such a configuration, the driving assistance system 1001 can display an appropriate travelable range of the moving object to the user. As a result, driving assistance system 1001 can improve operability and safety in driving of the moving object.

### Second Example Embodiment

### <Configuration of Driving Assistance System>

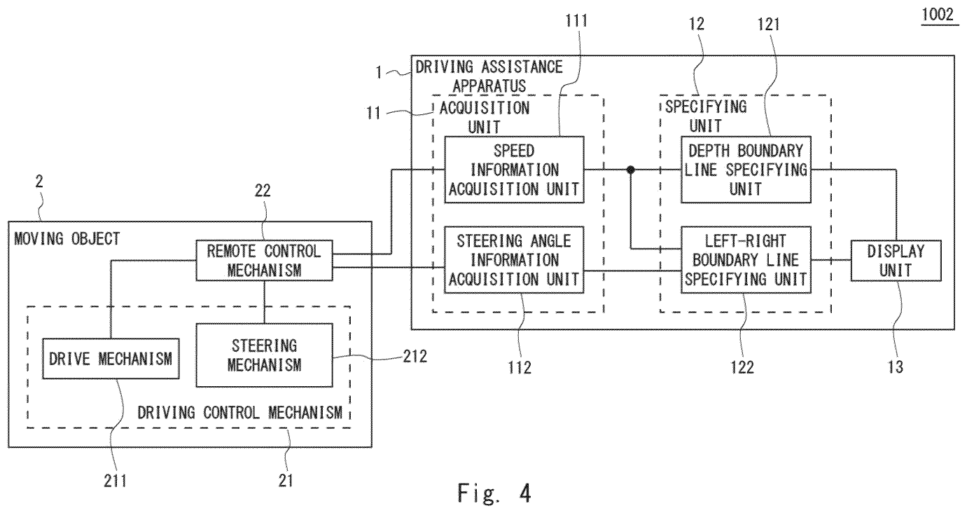

Hereinafter, a driving assistance system according to a second example embodiment will be described in detail with reference to the drawings. First, a configuration of the driving assistance system according to the second example embodiment will be described. FIG. 4 is a block diagram illustrating the configuration of the driving assistance system according to the second example embodiment.

A driving assistance system 1002 according to the present example embodiment assists a user who drives a moving object. More specifically, the driving assistance system 1002 specifies a region where the moving object can travel based on information regarding a driving operation amount of the moving object, and displays the specified region to the user.

The driving assistance system 1002 according to the present example embodiment includes the driving assistance apparatus 1 and the moving object 2.

The moving object 2 is driven by the user. The moving object 2 may be, for example, a vehicle traveling on the ground, a flying object, a ship, or a submarine. That is, the moving object 2 may be any object as long as the object is driven by the user and moves.

However, it is assumed that the moving object 2 according to the present example embodiment is a four-wheeled vehicle that travels on the ground.

The moving object 2 may be driven by the user riding on the moving object 2 or may be remotely operated by the user not riding on the moving object 2.

However, the moving object 2 according to the present example embodiment is assumed to be driven under remote control by the user not riding on the moving object 2.

The moving object 2 includes a driving control mechanism 21 and a remote control mechanism 22.

The driving control mechanism 21 adjusts a moving speed and a moving direction of the moving object based on a driving operation of the user. More specifically, the driving control mechanism 21 is operated by the remote control mechanism 22 that mechanically operates based on a remote control signal from the user, and adjusts the moving speed and the moving direction of the moving object.

The driving control mechanism 21 includes a drive mechanism 211 and a steering mechanism 212.

The drive mechanism 211 is operated by the remote control mechanism 22 that mechanically operates based on the remote control signal from the user, and adjusts the moving speed of the moving object 2. The drive mechanism 211 may refer to, for example, a generic term for a driving power source such as an engine, a driving power transmission mechanism such as a reduction gear, an output destination of driving power such as a wheel or a screw propeller, and a mechanism that adjusts an output amount of driving power such as an accelerator or a brake.

Note that a sensor may be attached to components of the drive mechanism 211. Then, information detected by the sensor may be output to the remote control mechanism 22 as information regarding the driving control mechanism 21.

The steering mechanism 212 controls the moving direction of the moving object 2 based on control of the user via the remote control mechanism 22. The steering mechanism 212 may refer to, for example, a generic term for a mechanism that adjusts a steering angle of the moving object 2 such as a steering shaft or a steering wheel.

Note that a sensor may be attached to components of the steering mechanism 212. Then, information detected by the sensor may be output to the remote control mechanism 22 as information regarding the driving control mechanism 21.

The remote control mechanism 22 mechanically operates based on remote control from the user, and operates the driving control mechanism 21 of the moving object 2. In addition, the remote control mechanism 22 transmits the information regarding the driving control mechanism 21 to the driving assistance apparatus 1. That is, the remote control mechanism 22 has a function of operating the driving control mechanism 21 and a function of communicating with the user and the driving assistance apparatus 1.

The remote control mechanism 22 mechanically operates the driving control mechanism 21 based on remote control from the user. The remote control mechanism 22 may include, for example, an apparatus that depresses the accelerator or the brake of the moving object 2 based on remote control of the user.

In addition, for example, the remote control mechanism 22 may include an apparatus that rotates the steering wheel included in the moving object 2 based on remote control from the user.

Note that the remote control mechanism 22 according to the present example embodiment mechanically operates the driving control mechanism 21 based on the remote control from the user, but the remote control mechanism 22 may be configured to output the remote control signal from the user to a control unit (not illustrated) of the driving control mechanism 21.

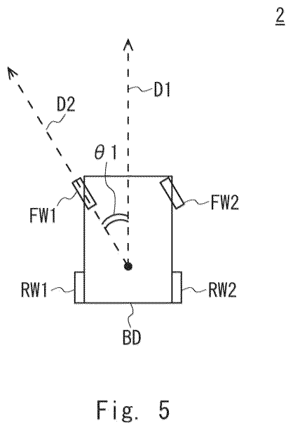

FIG. 5 is a schematic overhead view illustrating an example of the moving object 2 according to the second example embodiment.

As illustrated in FIG. 5, the moving object 2 in the present example embodiment includes a vehicle body BD, front wheels FW1 and FW2, and rear wheels RW1 and RW2.

However, in the following description, the front wheels FW1 and FW2 and the rear wheels RW1 and RW2 will be simply referred to as front wheels FW and rear wheels RW, respectively, if distinguishment is not required.

The vehicle body BD is equipped with the driving control mechanism 21 and the remote control mechanism 22 described above. The vehicle body BD travels by driving power output to the rear wheels RW, and determines the moving direction by a steering angle of the front wheels FW. That is, the moving object 2 according to the present example embodiment is a front wheel steering vehicle and a rear wheel drive vehicle.

The steering mechanism 212 is connected to the front wheels FW to adjust steering angle.

Note that the front wheels FW may be regarded as a part of the steering mechanism 212.

In addition, the steering angle of the front wheels FW refers to an angle between a front direction of the vehicle body BD and a rotation direction of the front wheels FW. That is, the steering angle in the present example embodiment refers to an angle θ1 between a front direction DI and a rotation direction D2 illustrated in FIG. 5.

The drive mechanism 211 described above is connected to the rear wheels RW to output the driving power.

Note that the rear wheels RW may be regarded as a part of the drive mechanism 211.

However, a configuration of the moving object 2 described with reference to FIG. 5 is an example, and a configuration of the moving object 2 to which the technology according to the present disclosure can be applied is not limited thereto.

For example, the moving object 2 may be a front wheel drive vehicle or a rear wheel steering vehicle.

In addition, the moving object 2 may be a flying object or a ship as described above, and in these cases, a steering angle may be defined as, for example, an angle formed by the front direction of the moving object 2 and a rudder of the moving object 2.

That is, the steering angle may be defined as an angle of a rudder included in the steering mechanism 212.

The description returns to FIG. 4.

The driving assistance apparatus 1 specifies the region where the moving object can travel based on the information regarding the driving control mechanism 21, and displays the specified region to the user.

More specifically, the driving assistance apparatus 1 according to the present example embodiment receives the information regarding the driving control mechanism 21 from the remote control mechanism 22 provided in the moving object 2, specifies the region where the moving object can travel based on the information, and displays the specified region to the user.

The driving assistance apparatus 1 includes the acquisition unit 11, the specifying unit 12, and the display information generation unit 13.

The acquisition unit 11 acquires the information regarding the driving control mechanism 21. More specifically, the acquisition unit 11 receives the information regarding the driving control mechanism 21 from the remote control mechanism 22. That is, the acquisition unit 11 may have a function as a communication apparatus.

Here, the information regarding the driving control mechanism 21 in the present example embodiment includes information regarding the steering angle and the moving speed of the moving object 2.

The acquisition unit 11 includes a speed information acquisition unit 111 and a steering angle information acquisition unit 112.

The speed information acquisition unit 111 acquires the information regarding the moving speed of the moving object 2, that is, information regarding the drive mechanism 211 among pieces of the information regarding the driving control mechanism 21.

The speed information acquisition unit 111 outputs the acquired information to the specifying unit 12.

The information regarding the moving speed of the moving object 2 may include, for example, information regarding a current value of speed of the moving object 2, information regarding an upper limit value of speed of the moving object 2, or information regarding an upper limit value of acceleration of the moving object 2.

Note that the information regarding the upper limit value of acceleration may be information regarding an upper limit value of positive acceleration with respect to a traveling direction, or may be information regarding an upper limit value of negative acceleration with respect to the traveling direction. In other words, the information regarding the upper limit value of acceleration may be information regarding an upper limit value of acceleration in a direction of accelerating the moving object 2 or may be information regarding an upper limit value of acceleration in a direction of decelerating the moving object 2.

The speed information acquisition unit 111 may acquire a specific numerical value of the speed or a specific numerical value of the acceleration of the moving object 2, or both as the information regarding the moving speed of the moving object 2.

The speed information acquisition unit 111 may acquire a parameter value of each apparatus belonging to the drive mechanism 211 as the information regarding the moving speed of the moving object 2. In addition, the speed information acquisition unit 111 may acquire a detection value of a sensor provided in each apparatus belonging to the drive mechanism 211 as the information regarding the moving speed of the moving object 2, that is, the speed or the acceleration of the moving object 2, or both.

In these cases, the speed information acquisition unit 111 may calculate a specific numerical value of the speed or a specific numerical value of the acceleration of the moving object 2, or both from the acquired parameter values.

The steering angle information acquisition unit 112 acquires the information regarding the steering angle of the moving object 2, that is, information regarding the steering mechanism 212 among pieces of the information regarding the driving control mechanism 21.

The steering angle information acquisition unit 112 outputs the acquired information to the specifying unit 12.

The information regarding the steering angle of the moving object 2 may include, for example, information regarding a current value of the steering angle of the moving object 2, information regarding a range that can be taken by a value of the steering angle of the moving object 2, or information regarding an upper limit value of a change speed of the steering angle of the moving object 2.

Here, the range that can be taken by the value of the steering angle of the moving object 2 may be a range of values that can be taken in terms of a structure of the steering mechanism 212, a range of values of the steering angle that can change within a predetermined time, a range of values of the steering angle that can change until the moving object 2 moves a predetermined distance, or a range including a plurality of these ranges. However, the range of values of the steering angle that can change until the moving object 2 moves the predetermined distance may be calculated by the specifying unit 12.

In addition, the change speed of the steering angle of the moving object 2 is an increase or a decrease of the value of the steering angle per unit time.

The steering angle information acquisition unit 112 may acquire a specific numerical value of the steering angle of the moving object 2 or a specific numerical value of the change speed of the steering angle, or both as the information regarding the steering angle of the moving object 2.

The steering angle information acquisition unit 112 may acquire a parameter value of each apparatus belonging to the steering mechanism 212 as the information regarding the steering angle of the moving object 2. In addition, the steering angle information acquisition unit 112 may acquire a detection value of a sensor provided in each apparatus belonging to the steering mechanism 212 as the information regarding the steering angle of the moving object 2.

In these cases, the steering angle information acquisition unit 112 may calculate a specific numerical value of the steering angle of the moving object 2 or a specific numerical value of the change speed of the steering angle, or both from the acquired parameter values.

In addition, the information regarding the upper limit value of the change speed of the steering angle of the moving object 2 may include information regarding the remote control mechanism 22.

For example, the information regarding the upper limit value of the change speed of the steering angle of the moving object 2 may include information regarding an operation delay of the remote control mechanism 22 or information regarding an output limit of the remote control mechanism 22 as the information regarding the remote control mechanism 22.

Note that the information regarding the operation delay of the remote control mechanism 22 is information regarding a time until the remote control mechanism 22 causes the driving control mechanism 21 to execute a driving operation since input of the driving operation from the user.

In addition, the information regarding the output limit of the remote control mechanism 22 is information regarding the output limit of a mechanical component of the remote control mechanism 22 provided for operating the driving control mechanism 21. For example, in a case where the remote control mechanism 22 includes an apparatus that rotates the steering wheel, the steering angle information acquisition unit 112 may acquire a maximum value of a torque that can be output by the apparatus that rotates the steering wheel as the information regarding the output limit of the remote control mechanism 22.

The specifying unit 12 specifies the region where the moving object 2 can travel based on the information acquired by the acquisition unit 11. More specifically, the specifying unit 12 specifies a boundary line of the travelable region based on the information regarding the steering angle and the moving speed of the moving object 2, and specifies a region surrounded by the specified boundary line as the travelable region.

The specifying unit 12 includes a depth boundary line specifying unit 121 and a left-right boundary line specifying unit 122.

Note that the travelable region described herein may be defined as a travelable region in terms of performance of the driving control mechanism 21 predicted from various actual measurement values, parameter values, or prescribed values.

In addition, the travelable region may be defined as a region in which the moving object 2 can safely travel. That is, it may be a region calculated with a virtual limitation on the performance of the driving control mechanism 21 from the viewpoint of suppressing the occurrence of an unexpected accident.

Furthermore, the travelable region may be a value approximately calculated using various values regarding the driving control mechanism 21.

In other words, the travelable region according to the present example embodiment may be a theoretically travelable region calculated from various values regarding the driving control mechanism 21, or may be a region as a guide presented to the user in order to cause the moving object 2 to safely travel.

Here, in a case where the travelable region is the region as the guide presented to the user in order to cause the moving object 2 to safely travel, the travelable region is preferably a region narrower than the theoretically travelable region calculated from the various values regarding the driving control mechanism 21.

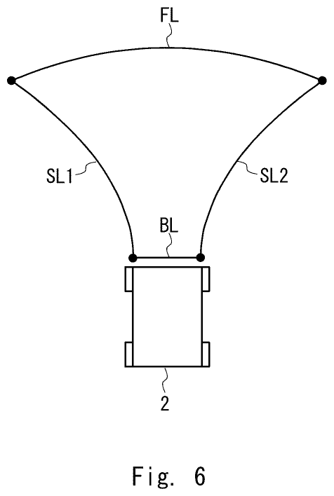

FIG. 6 is a schematic overhead view illustrating an example of a travelable region according to the second example embodiment.

The specifying unit 12 according to the present example embodiment specifies a depth boundary line FL indicating the travelable range of the moving object 2 in the traveling direction and left-right boundary lines SL1 and SL2 indicating the travelable range of the moving object 2 in the left-right direction as viewed in the traveling direction. Then, the specifying unit 12 specifies, as the travelable region, a region surrounded by the depth boundary line FL, the left-right boundary lines SL1 and SL2, and a boundary line BL corresponding to a side surface portion of the moving object 2 in the traveling direction.

The depth boundary line specifying unit 121 specifies a boundary line indicating a range in which the moving object 2 can travel in the traveling direction. That is, the depth boundary line specifying unit 121 specifies the depth boundary line FL in FIG. 6.

For example, the depth boundary line specifying unit 121 may specify the depth boundary line FL based on the information regarding the moving speed of the moving object 2.

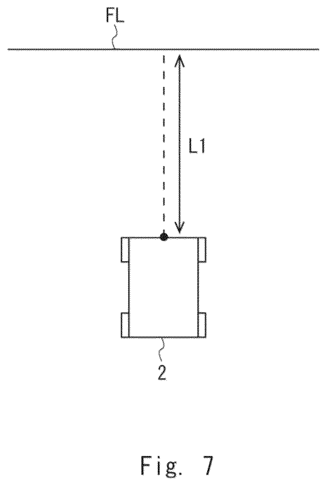

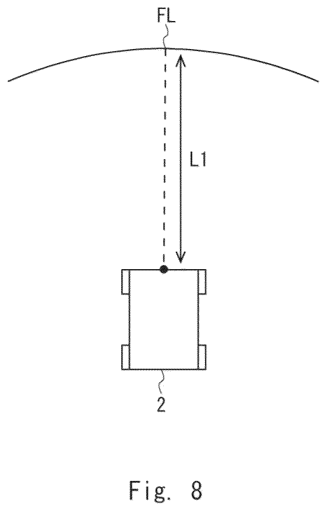

FIGS. 7 and 8 are schematic overhead views illustrating examples of a boundary line of a travelable region according to the second example embodiment.

For example, as illustrated in FIG. 7, the depth boundary line specifying unit 121 may specify, as the depth boundary line FL, a straight line spaced apart from the moving object 2 by a length L1 determined based on the information regarding the moving speed of the moving object 2.

In addition, for example, as illustrated in FIG. 8, the depth boundary line specifying unit 121 may specify, as the depth boundary line FL, an arc having a radius of the length L1 determined based on the information regarding the moving speed of the moving object 2 and having one point of the side surface portion of the moving object 2 in the traveling direction as a center point.

Here, the length L1 may be determined based on, for example, a current value of the moving speed of the moving object 2. The length L1 may be determined so as to be smaller as the moving speed of the moving object 2 increases, or may be determined so as to be smaller as the acceleration in the traveling direction of the moving object 2 increases.

According to such a configuration, the travelable region to be presented to the user becomes narrower as the moving speed of the moving object 2 increases. When the travelable region is narrowed, the user executes the driving operation with more attention, and as a result, the occurrence of an accident can be suppressed.

In addition, for example, the length L1 may be determined based on a distance between the moving object 2 and an obstacle and a braking distance of the moving object 2.

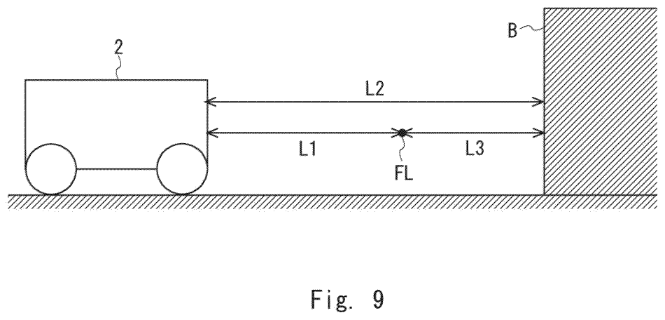

FIG. 9 is a schematic side view illustrating an example of a boundary line of a travelable region according to the second example embodiment. More specifically, it is a schematic side view for describing a method of calculating the length L1 in a case where the length L1 is determined based on the distance between the moving object 2 and the obstacle and the braking distance of the moving object 2.

Here, a length L2 in FIG. 9 represents a distance between the moving object 2 and an obstacle B, and a length L3 represents the braking distance of the moving object 2.

As illustrated in FIG. 9, the length L1 may be determined as a length obtained by subtracting the braking distance L3 of the moving object 2 from the distance L2 from the moving object 2 to the obstacle.

Note that the distance L2 from the moving object 2 to the obstacle may be, for example, information detected by a sensor attached to a position where the moving object 2 or a moving object such as a ceiling or a beam can be viewed from above and transmitted to the driving assistance apparatus 1, or may be a value calculated from position information of the moving object 2 and position information of the obstacle.

In addition, the braking distance L3 of the moving object 2 may be a value calculated based on the moving speed of the moving object 2.

According to such a configuration, the depth boundary line specifying unit 121 can appropriately set the boundary line along which the moving object 2 can safely travel, and the occurrence of an accident or the like can be suppressed.

The description returns to FIG. 4.

The left-right boundary line specifying unit 122 specifies the boundary lines indicating the range in which the moving object 2 can travel in the left-right direction viewed in the traveling direction. That is, the left-right boundary line specifying unit 122 specifies the left-right boundary lines SL1 and SL2 in FIG. 6.

For example, the left-right boundary line specifying unit 122 may specify the left-right boundary lines SL1 and SL2 based on the information regarding the steering angle and the moving speed of the moving object 2.

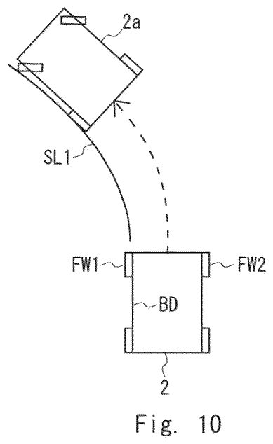

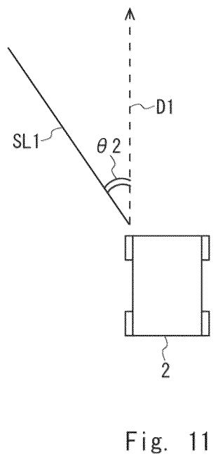

FIG. 10 is a schematic overhead view illustrating an example of a boundary line of a travelable region according to the second example embodiment. More specifically, it is a schematic overhead view illustrating an example of a boundary line in the left direction as viewed in the traveling direction out of the left-right boundary lines.

In FIG. 10, 2a denotes the moving object 2 in a case where the moving object 2 is caused to travel at a constant speed while the steering angle of the moving object 2 is changed in the left direction as viewed in the traveling direction such that the change speed becomes the upper limit value. That is, the moving object 2a indicates a position of the moving object 2 when turning leftward as much as possible at a set speed.

The left-right boundary line specifying unit 122 may calculate a trajectory until the moving object 2 reaches a position of the moving object 2a based on the information regarding the steering angle and the moving speed of the moving object 2. Then, the left-right boundary line specifying unit 122 may specify, as the left-right boundary line SL1, a trajectory through which a left side surface of the vehicle body BD of the moving object 2 passes until the moving object 2 reaches the position of the moving object 2a.

That is, the left-right boundary line specifying unit 122 may specify, as the left-right boundary line SL1, an estimated trajectory through which the side surface portion of the moving object 2 located on the left side as viewed in the traveling direction passes when the moving object 2 is caused to travel at the constant speed while changing the steering angle of the moving object 2 in the left direction as viewed in the traveling direction such that the change speed becomes the upper limit value.

According to such a configuration, it is possible to more accurately specify a region that the moving object 2 can theoretically reach.

Note that, out of the left-right boundary lines, a boundary line in the right direction as viewed in the traveling direction, that is, the left-right boundary line SL2 can also be specified in the same manner as in the above example.

That is, the left-right boundary line specifying unit 122 may specify, as the boundary line of the region in which the moving object 2 can travel, an estimated trajectory through which the side surface portion of the moving object 2 located on the right side as viewed in the traveling direction passes when the moving object 2 is caused to travel at the constant speed while changing the steering angle of the moving object 2 in the right direction as viewed in the traveling direction such that the change speed becomes the upper limit value.

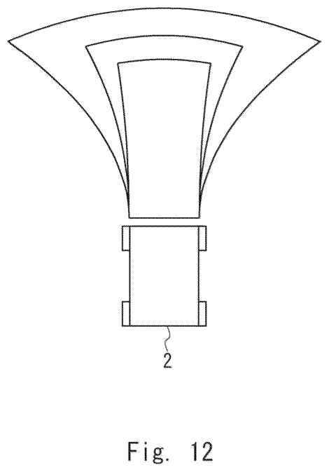

FIG. 11 is a schematic overhead view illustrating an example of a boundary line of a travelable region according to the second example embodiment. More specifically, it is a schematic overhead view illustrating an example of a boundary line in the left direction as viewed in the traveling direction out of the left-right boundary lines.

As illustrated in FIG. 11, the left-right boundary line specifying unit 122 may specify a straight line with which an angle of the front direction DI of the moving object 2 is an angle θ2 as the left-right boundary line SL1.

The angle θ2 may be an angle calculated based on the information regarding the steering angle and the moving speed of the moving object 2. The angle θ2 is preferably calculated to be larger as the steering angle is steered leftward, calculated to be larger as the upper limit value of the change speed of the steering angle increases, and calculated to be smaller as the moving speed of the moving object 2 increases.

According to such a configuration, processing for specifying the left-right boundary line SL1 can be simplified.

Note that, out of the left-right boundary lines, a boundary line in the right direction as viewed in the traveling direction, that is, the left-right boundary line SL2 can also be specified in the same manner as in the above example.

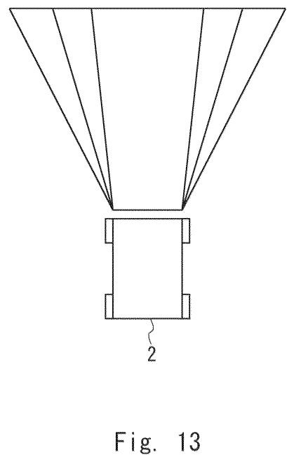

FIG. 12 is a schematic overhead view illustrating a travelable region according to the second example embodiment.

The specifying unit 12 may specify a region surrounded by the depth boundary line FL specified as illustrated in FIG. 8 and the left-right boundary lines SL1 and SL2 specified as illustrated in FIG. 10 as the travelable region.

In this case, the specifying unit 12 may set a plurality of predetermined speeds and specify a plurality of travelable regions on the assumption that the moving speed of the moving object 2 is each of the speeds. Then, the plurality of specified regions may be output in a superimposed manner to the display information generation unit 13 as illustrated in FIG. 12.

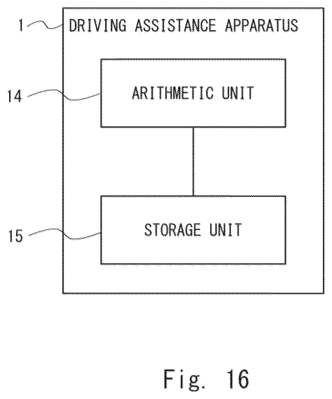

FIG. 15 is a schematic overhead view illustrating a travelable region according to the second example embodiment.

The specifying unit 12 may specify a region surrounded by the depth boundary line FL specified as illustrated in FIG. 7 and the left-right boundary lines SL1 and SL2 specified as illustrated in FIG. 11 as the travelable region.

In this case, the specifying unit 12 may set a plurality of predetermined speeds and specify a plurality of the left-right boundary lines SL1 and SL2 on the assumption that the moving speed of the moving object 2 is each of the speeds. Then, a plurality of travelable regions may be specified based on the plurality of left-right boundary lines SL1 and SL2, and the specified regions may be output in a superimposed manner to the display information generation unit 13 as illustrated in FIG. 13.

The description returns to FIG. 4.

The display information generation unit 13 displays the region specified by the specifying unit 12 to the user. The display information generation unit 13 may be, for example, a display apparatus installed at a position visually recognizable by the user during the driving operation, or may be a wearable terminal that can be worn by the user.

In addition, the display information generation unit 13 may be a transmitter that transmits image data to be displayed to the user to the display apparatus or the wearable terminal.

The display information generation unit 13 may display the region specified by the specifying unit 12 to be superimposed on, for example, a map of an area where the moving object 2 moves.

In addition, the display information generation unit 13 may display the region specified by the specifying unit 12 to be superimposed on, for example, an image obtained by capturing an image of a state of the moving object 2 in the traveling direction.

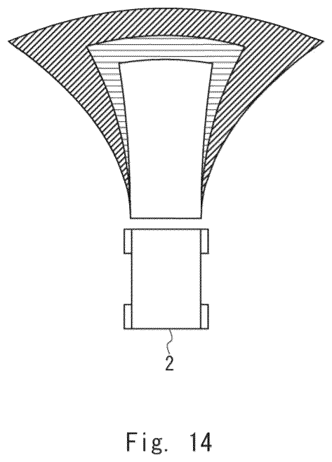

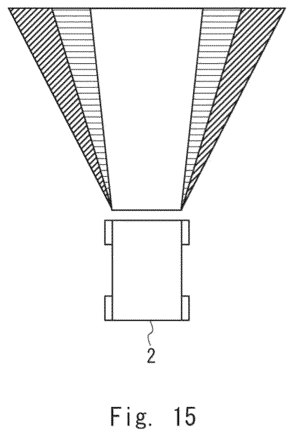

In addition, when the specifying unit 12 outputs the plurality of regions in a superimposed manner as illustrated in FIGS. 12 and 13, the display information generation unit 13 may display the respective regions in different colors as illustrated in FIGS. 14 and 15, or may distinguish display formats of the respective boundary lines by a broken line, a wavy line, and the like. In addition, the display information generation unit 13 may distinguish the plurality of regions by blinking at different timings or by displaying the regions with different brightness or saturation.

Note that some or all of the functions of the driving assistance apparatus 1 described above may be executed by an arithmetic unit included in the driving assistance apparatus 1.

FIG. 16 is a block diagram illustrating an example of the driving assistance apparatus according to the second example embodiment.

As illustrated in FIG. 16, the driving assistance apparatus 1 may include an arithmetic unit 14 such as a central processing unit (CPU) and a storage unit 15 such as a random access memory (RAM) or a read only memory (ROM) in which a program, data, and the like for controlling the driving assistance apparatus 1 are stored. That is, the driving assistance apparatus 1 has a function as a computer, and the functions of the driving assistance apparatus 1 described above may be executed based on the program described above.

Therefore, each functional block constituting the driving assistance apparatus 1 illustrated in FIG. 4 can be configured by the CPU, the storage unit, other circuits, and the like described above in terms of hardware, and can be implemented by the program and the like for controlling the driving assistance apparatus 1 stored in the storage unit in terms of software. That is, the driving assistance apparatus 1 can be implemented in various forms by hardware, software, or a combination of both.

### <Operation of Driving Assistance System>

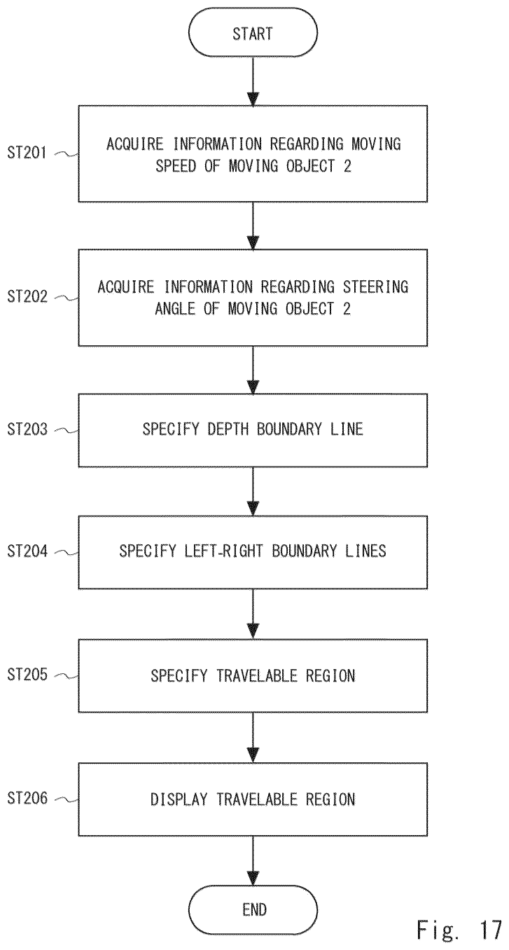

Next, an operation of the driving assistance system according to the second example embodiment, that is, a driving assistance method will be described in detail with reference to the drawings. FIG. 17 is a flowchart illustrating the operation of the driving assistance system according to the second example embodiment, and more specifically, is a flowchart illustrating an operation of the driving assistance apparatus 1. Note that FIG. 4 will be appropriately referred to in the following description.

First, the speed information acquisition unit 111 acquires information regarding a moving speed of the moving object 2 (step ST201). Next, the steering angle information acquisition unit 112 acquires information regarding a steering angle of the moving object 2 (step ST202).

However, the execution order of steps ST201 and ST202 may be inverted. In addition, steps ST201 and ST202 may be executed in parallel.

Next, the depth boundary line specifying unit 121 specifies the depth boundary line FL (step ST203). More specifically, the depth boundary line specifying unit 121 specifies a boundary line indicating a range in which the moving object 2 can travel in a traveling direction.

Next, the left-right boundary line specifying unit 122 specifies a left-right boundary line SL (step ST204). More specifically, the left-right boundary line specifying unit 122 specifies a boundary line indicating a range in which the moving object 2 can travel in the left-right direction viewed in the traveling direction.

However, the execution order of steps ST203 and ST204 may be inverted. In addition, steps ST203 and ST204 may be executed in parallel.

Next, the specifying unit 12 specifies a travelable region (step ST205). More specifically, a region surrounded by the depth boundary line specified in step ST203, the left-right boundary line specified in step ST204, and the boundary line BL corresponding to a side surface portion of the moving object 2 in the traveling direction is specified as the travelable region.

Finally, the display information generation unit 13 displays the travelable region (step ST206), and the driving assistance apparatus 1 ends the series of operations. More specifically, the region specified in step ST205 is displayed to a user, and the series of operations is ended.

The driving assistance apparatus 1 continuously executes the above-described series of operations during driving of the moving object 2. For example, the driving assistance apparatus 1 may execute the above-described series of operations at predetermined time intervals, or may continuously execute the respective steps in parallel.

As described above, the driving assistance system 1002 according to the present example embodiment specifies the region where the moving object can travel based on the information regarding the driving control mechanism 21, and displays the specified region to the user.

According to such a configuration, the driving assistance system 1002 can display an appropriate travelable range of the moving object to the user. As a result, the driving assistance system 1002 can improve operability and safety in driving of the moving object.

### Other Example Embodiments

Although the acquisition unit 11 acquires information from the driving control mechanism 21 via the remote control mechanism 22 in the second example embodiment, the acquisition unit 11 may acquire information from the driving control mechanism 21 without the intervention of the remote control mechanism 22.

Also with such a configuration, the driving assistance system according to the present disclosure can display an appropriate travelable range of a moving object to a user.

The specifying unit 12 according to the present disclosure may specify a travelable region of the moving object 2 based on information regarding a cargo loaded on the moving object 2.

For example, the specifying unit 12 may specify a travelable region by calculating an inertial force related to the cargo loaded on the moving object 2 based on information regarding a steering angle of the moving object 2 and information regarding a moving speed and limiting the inertial force so as to fall within a range in which the cargo does not move.

According to such a configuration, it is possible to specify the travelable region in which safety is further ensured. As a result, for example, it is possible to appropriately execute driving assistance of a moving object transporting a cargo such as a forklift.

Although the present disclosure has been described in accordance with the above-described example embodiments, the present disclosure is not limited to the configurations of the above-described example embodiments, and includes not only combinations of above-described example embodiments but also various modifications, modifications, and combinations that can be made by those skilled in the art within the scope of the claims of the present application.

Some or all of the above-described example embodiments may be described as in the following Supplementary Notes, but are not limited to the following Supplementary Notes.

### Supplementary Note 1

A driving assistance system including:
an acquisition unit that acquires information regarding a driving operation amount of a moving object;
a specifying unit that specifies a region where the moving object is travelable based on the information regarding the driving operation amount acquired by the acquisition unit; and
a display information generation unit that displays the region specified by the specifying unit to a user.

### Supplementary Note 2

The driving assistance system according to Supplementary Note 1, wherein the specifying unit specifies a region where the moving object is travelable in terms of performance as the region where the moving object is travelable.

### Supplementary Note 3

The driving assistance system according to Supplementary Note 1 or 2, wherein
the information regarding the driving operation amount of the moving object includes information regarding a steering angle of the moving object, and
the specifying unit specifies a boundary line of the travelable region based on the information regarding the steering angle of the moving object.

### Supplementary Note 4

The driving assistance system according to Supplementary Note 3, wherein the information regarding the steering angle of the moving object includes information regarding an upper limit value of a change speed of the steering angle of the moving object.

### Supplementary Note 5

The driving assistance system according to Supplementary Note 4, wherein
the moving object includes a remote control mechanism that operates a steering mechanism of the moving object based on remote control by the user, and
the information regarding the upper limit value of the change speed of the steering angle of the moving object includes information regarding the remote control mechanism.

### Supplementary Note 6

The driving assistance system according to any one of Supplementary Notes 1 to 5, wherein the specifying unit specifies a boundary line indicating a range in which the moving object is travelable in a left-right direction as a boundary line of the travelable region.

### Supplementary Note 7

The driving assistance system according to any one of Supplementary Notes 1 to 6, wherein the specifying unit specifies a boundary line indicating a range in which the moving object is travelable in a traveling direction based on information regarding a moving speed of the moving object.

### Supplementary Note 8

A driving assistance apparatus including:

an acquisition unit that acquires information regarding a driving operation amount of a moving object;
a specifying unit that specifies a region where the moving object is travelable based on the information regarding the driving operation amount acquired by the acquisition unit; and
a display information generation unit that displays the region specified by the specifying unit to a user.

### Supplementary Note 9

The driving assistance apparatus according to Supplementary Note 8, wherein the specifying unit specifies a region where the moving object is travelable in terms of performance as the region where the moving object is travelable.

### Supplementary Note 10

The driving assistance apparatus according to Supplementary Note 8 or 9, wherein
the information regarding the driving operation amount of the moving object includes information regarding a steering angle of the moving object, and
the specifying unit specifies a boundary line of the travelable region based on the information regarding the steering angle of the moving object.

### Supplementary Note 11

The driving assistance apparatus according to Supplementary Note 10, wherein the information regarding the steering angle of the moving object includes information regarding an upper limit value of a change speed of the steering angle of the moving object.

### Supplementary Note 12

The driving assistance apparatus according to Supplementary Note 11, wherein
the moving object includes a remote control mechanism that operates a steering mechanism of the moving object based on remote control by the user, and
the information regarding the upper limit value of the change speed of the steering angle of the moving object includes information regarding the remote control mechanism.

### Supplementary Note 13

The driving assistance apparatus according to any one of Supplementary Notes 8 to 12, wherein the specifying unit specifies a boundary line indicating a range in which the moving object is travelable in a left-right direction as a boundary line of the travelable region.

### Supplementary Note 14

The driving assistance apparatus according to any one of Supplementary Notes 8 to 13, wherein the specifying unit specifies a boundary line indicating a range in which the moving object is travelable in a traveling direction based on information regarding a moving speed of the moving object.

### Supplementary Note 15

A driving assistance method including:
acquiring information regarding a driving operation amount of a moving object;
specifying a region where the moving object is travelable based on the acquired information regarding the driving operation amount; and
displaying the specified region to a user.

### Supplementary Note 16

The driving assistance method according to Supplementary Note 15, wherein a region where the moving object is travelable in terms of performance is specified as the region where the moving object is travelable.

### Supplementary Note 17

The driving assistance method according to Supplementary Note 15 or 16, wherein
the information regarding the driving operation amount of the moving object includes information regarding a steering angle of the moving object, and
a boundary line of the travelable region is specified based on the information regarding the steering angle of the moving object.

### Supplementary Note 18

The driving assistance method according to Supplementary Note 17, wherein the information regarding the steering angle of the moving object includes information regarding an upper limit value of a change speed of the steering angle of the moving object.

### Supplementary Note 19

The driving assistance method according to Supplementary Note 18, wherein
the moving object includes a remote control mechanism that operates a steering mechanism of the moving object based on remote control by the user, and
the information regarding the upper limit value of the change speed of the steering angle of the moving object includes information regarding the remote control mechanism.

### Supplementary Note 20

The driving assistance method according to any one of Supplementary Notes 15 to 19, wherein a boundary line indicating a range in which the moving object is travelable in a left-right direction is specified as a boundary line of the travelable region.

### Supplementary Note 21

The driving assistance method according to any one of Supplementary Notes 15 to 20, wherein a boundary line indicating a range in which the moving object is travelable in a traveling direction is specified based on information regarding a moving speed of the moving object.

### REFERENCE SIGNS LIST

1 DRIVING ASSISTANCE APPARATUS
2 MOVING OBJECT
11 ACQUISITION UNIT
12 SPECIFYING UNIT
13 DISPLAY INFORMATION GENERATION UNIT
21 DRIVING CONTROL MECHANISM
22 REMOTE CONTROL MECHANISM
111 SPEED INFORMATION ACQUISITION UNIT
112 STEERING ANGLE INFORMATION ACQUISITION UNIT
121 DEPTH BOUNDARY LINE SPECIFYING UNIT
122 LEFT-RIGHT BOUNDARY LINE SPECIFYING UNIT
211 DRIVE MECHANISM
212 STEERING MECHANISM
FT, FT1, FT2 FRONT WHEEL
BT, BT1, BT2 REAR WHEEL
1001, 1002, 1003 DRIVING ASSISTANCE SYSTEM

What is claimed is:

1. A driving assistance system comprising:
at least one memory storing instructions, and
at least one processor configured to execute the instructions to;
acquire information regarding a driving operation amount of a moving object;
specify a region where the moving object is travelable based on the information regarding the driving operation amount; and
display the region to a user.

2. The driving assistance system according to claim 1, wherein the at least one processor is further configured to execute the instructions to specify a region where the moving object is travelable in terms of performance as the region where the moving object is travelable.

3. The driving assistance system according to claim 1, wherein
the information regarding the driving operation amount of the moving object includes information regarding a steering angle of the moving object, and
the at least one processor is further configured to execute the instructions to specify a boundary line of the travelable region based on the information regarding the steering angle of the moving object.

4. The driving assistance system according to claim 3, wherein the information regarding the steering angle of the moving object includes information regarding an upper limit value of a change speed of the steering angle of the moving object.

5. The driving assistance system according to claim 4, wherein
the moving object includes a remote control mechanism that operates a steering mechanism of the moving object based on remote control by the user, and
the information regarding the upper limit value of the change speed of the steering angle of the moving object includes information regarding the remote control mechanism.

6. The driving assistance system according to claim 1, wherein the at least one processor is further configured to execute the instructions to specify a boundary line indicating a range in which the moving object is travelable in a left-right direction as a boundary line of the travelable region.

7. The driving assistance system according to claim 1, wherein the at least one processor is further configured to execute the instructions to specify a boundary line indicating a range in which the moving object is travelable in a traveling direction based on information regarding a moving speed of the moving object.

8. A driving assistance apparatus comprising:
at least one memory storing instructions, and
at least one processor configured to execute the instructions to;
acquire information regarding a driving operation amount of a moving object;
specify a region where the moving object is travelable based on the information regarding the driving operation amount; and
display the region to a user.

9. The driving assistance apparatus according to claim 8, wherein
the information regarding the driving operation amount of the moving object includes information regarding a steering angle of the moving object, and
the at least one processor is further configured to execute the instructions to specify a boundary line of the travelable region based on the information regarding the steering angle of the moving object.

10. The driving assistance apparatus according to claim 9, wherein the information regarding the steering angle of the moving object includes information regarding an upper limit value of a change speed of the steering angle of the moving object.

11. The driving assistance apparatus according to claim 10, wherein
the moving object includes a remote control mechanism that operates a steering mechanism of the moving object based on remote control by the user, and
the information regarding the upper limit value of the change speed of the steering angle of the moving object includes information regarding the remote control mechanism.

12. The driving assistance apparatus according to claim 8, wherein the at least one processor is further configured to execute the instructions to specify a boundary line indicating a range in which the moving object is travelable in a left-right direction as a boundary line of the travelable region.

13. The driving assistance apparatus according to claim 8, wherein the at least one processor is further configured to execute the instructions to specify a boundary line indicating a range in which the moving object is travelable in a traveling direction based on information regarding a moving speed of the moving object.

14. A driving assistance method comprising:
acquiring information regarding a driving operation amount of a moving object;
specifying a region where the moving object is travelable based on the acquired information regarding the driving operation amount; and
displaying the specified region to a user.

15. The driving assistance method according to claim 14, wherein a region where the moving object is travelable in terms of performance is specified as the region where the moving object is travelable.

16. The driving assistance method according to claim 14, wherein
the information regarding the driving operation amount of the moving object includes information regarding a steering angle of the moving object, and
a boundary line of the travelable region is specified based on the information regarding the steering angle of the moving object.

17. The driving assistance method according to claim 16, wherein the information regarding the steering angle of the moving object includes information regarding an upper limit value of a change speed of the steering angle of the moving object.

18. The driving assistance method according to claim 17, wherein
the moving object includes a remote control mechanism that operates a steering mechanism of the moving object based on remote control by the user, and
the information regarding the upper limit value of the change speed of the steering angle of the moving object includes information regarding the remote control mechanism.

19. The driving assistance method according to claim 14, wherein a boundary line indicating a range in which the moving object is travelable in a left-right direction is specified as a boundary line of the travelable region.

20. The driving assistance method according to claim 14, wherein a boundary line indicating a range in which the moving object is travelable in a traveling direction is specified based on information regarding a moving speed of the moving object.
